(19) United States
(12) Patent Application Publication
(10) Pub. No.: US 2021/0279973 A1
(43) Pub. Date: Sep. 9, 2021

(54) EASY LOCATION SHARING WITH LONG RANGE RADIO SPECTRUM

(71) Applicant: Toyota Motor Engineering & Manufacturing North America, Inc., Plano, TX (US)

(72) Inventor: Katsumi Nagata, Foster City, CA (US)

(21) Appl. No.: 16/808,123

(22) Filed: Mar. 3, 2020

(51) Int. Cl. G07C 5/00; G07C 5/08; H04W 52/02; H04W 36/00; H04W 76/19; H04W 4/021; H04W 4/029; H04W 4/40; H04W 4/90

(52) U.S. Cl. CPC G07C 5/006; G07C 5/085; G07C 5/0808; G07C 5/008; H04W 52/0241; H04W 4/90; H04W 76/19; H04W 4/021; H04W 4/029; H04W 4/40; H04W 36/0055

(57) ABSTRACT

A system for redundant communications in a vehicle includes a primary network access device designed to transmit and receive first data using a first protocol and a long-range radio transceiver designed to transmit and receive second data over at least one radio channel. The system further includes an electronic control unit (ECU) coupled to the primary network access device and the long-range radio transceiver. The ECU is designed to determine an out-of-range condition in response to the primary network access device being unable to at least one of transmit or receive the first data. The ECU is further designed to generate a transmission message to be sent via the long-range radio transceiver in response to determining the out-of-range condition. The ECU is further designed to control the long-range radio transceiver to transmit the transmission message via the at least one radio channel in response to determining the out-of-range condition.

### BACKGROUND

### 1. Field

The present disclosure relates to systems and methods for providing redundant communications in a vehicle and, in particular, to using a long-range radio transceiver to transmit and receive messages when a primary network access device of the vehicle is incapable of communication.

### 2. Description of the Related Art

Vehicles and their users are becoming more dependent upon wireless communication. For example, vehicles are now being designed to communicate their position, speed, and other information with each other. Also, users are becoming accustomed to being able to communicate with anyone from any location. Such communications are facilitated by advances in communication technology such as cellular telephones, network access devices installed in vehicles, and the like.

With the growth of cellular networks (e.g., 3G, 4G, 5G, etc.), many areas that once had no cellular coverage are now covered. However, there are still many areas of the world that are not covered by such cellular networks. Even in such areas that are out of cellular range, it is desirable for vehicles and their users to be able to communicate with other individuals and vehicles.

Thus, there is a need in the art for systems and methods for providing redundant vehicle communications.

### SUMMARY

Described herein is a system for redundant communications in a vehicle. The system includes a primary network access device designed to transmit and receive first data using a first protocol. The system further includes a long-range radio transceiver designed to transmit and receive second data over at least one radio channel. The system further includes an electronic control unit (ECU) coupled to the primary network access device and the long-range radio transceiver. The ECU is designed to determine an out-of-range condition in response to the primary network access device being unable to at least one of transmit or receive the first data. The ECU is further designed to generate a transmission message to be sent via the long-range radio transceiver in response to determining the out-of-range condition. The ECU is further designed to control the long-range radio transceiver to transmit the transmission message via the at least one radio channel in response to determining the out-of-range condition.

Also described is a system for redundant communications in a vehicle. The system includes an output device designed to output data. The system further includes a primary network access device designed to transmit and receive first data using a first protocol. The system further includes a long-range radio transceiver designed to transmit and receive second data over at least one radio channel. The system further includes an electronic control unit (ECU) coupled to the primary network access device and the long-range radio transceiver. The ECU is designed to determine an out-of-range condition in response to the primary network access device being unable to at least one of transmit or receive the first data. The ECU is further designed to generate a transmission message to be sent via the long-range radio transceiver in response to determining the out-of-range condition. The ECU is further designed to control the long-range radio transceiver to transmit the transmission message via the at least one radio channel in response to determining the out-of-range condition. The ECU is further designed to control the output device to output data indicating the out-of-range condition.

Also described is a method for redundant communications in a vehicle. The method includes transmitting and receiving first data via a primary network access device using a first protocol. The method further includes determining, by an electronic control unit (ECU), an out-of-range condition in response to the primary network access device being unable to at least one of transmit or receive the first data. The method further includes generating, by the ECU, a transmission message to be sent via a long-range radio transceiver over at least one radio channel in response to determining the out-of-range condition. The method further includes controlling, by the ECU, the long-range radio transceiver to transmit the transmission message via the at least one radio channel in response to determining the out-of-range condition.

### BRIEF DESCRIPTION OF THE DRAWINGS

Other systems, methods, features, and advantages of the present invention will be or will become apparent to one of ordinary skill in the art upon examination of the following figures and detailed description. It is intended that all such additional systems, methods, features, and advantages be included within this description, be within the scope of the present invention, and be protected by the accompanying claims. Component parts shown in the drawings are not necessarily to scale, and may be exaggerated to better illustrate the important features of the present invention. In the drawings, like reference numerals designate like parts throughout the different views, wherein:

FIG. 1 is a block diagram illustrating a system and a vehicle for providing redundant communications in a vehicle according to an embodiment of the present invention;

FIG. 2 is a block diagram illustrating various features of an electronic control unit (ECU) of the vehicle of FIG. 1 according to an embodiment of the present invention; and

FIGS. 3A, 3B, and 3C are flowcharts illustrating a method for providing redundant communications in a vehicle according to an embodiment of the present invention.

### DETAILED DESCRIPTION

The present disclosure describes systems and methods for providing redundant communications in a vehicle. The systems and methods provide various benefits and advantages such as allowing the vehicle to transmit and receive messages if a primary network access device of the vehicle is out of service or experiencing failure. This provides advantages such as allowing a user of the vehicle to communicate information, such as the location of the vehicle, to friends or colleagues even when the primary network access device of the vehicle is out of range. This also allows vehicles to communicate with each other when the primary network access device is out of range.

The systems and methods provide further advantages such as the ability to generate an emergency message in response to determining that an emergency condition (e.g., running out of fuel or involvement in an accident) has occurred. Because the vehicle is capable of redundant communications, a message corresponding to the emergency condition may be transmitted regardless of whether the primary network access device of the vehicle is in range. This may advantageously notify emergency services of the emergency condition, potentially saving lives of those in the vehicle.

An exemplary system includes a main, or primary, network access device designed to transmit and receive data using a first protocol. The system further includes a long-range radio transceiver designed to transmit and receive data over one or more radio channels. The system also includes an electronic control unit (ECU). The ECU is designed to determine whether the primary network access device is capable of transmitting and receiving messages. The ECU is also designed to generate a message to be sent based on one or more of user input or based on detection of an emergency condition. The ECU is further designed to control the long-range radio transceiver to transmit the message when the primary network access device is incapable of communications (e.g., if it is broken or out of range).

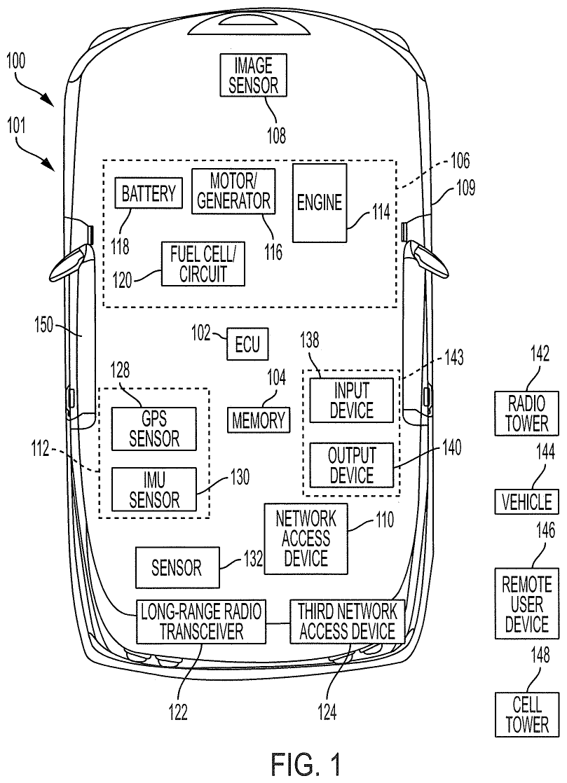

Turning to FIG. 1, a vehicle 100 may include a system 101 for providing redundant communications. The vehicle 100 (or system 101) may include an ECU 102, a memory 104, and a power source 106. The vehicle 100 (or system 101) may further include a primary network access device 110, a long-range radio transceiver 122, a third network access device 124, an image sensor 108, a sensor 132. The vehicle 100 may also include a multimedia unit 143 including an input device 138 and an output device 140.

The vehicle 100 may be propelled along a roadway, may be suspended in or on water, or may fly through air. The vehicle 100 may resemble a vehicle such as a car, a bus, a motorcycle, a boat, an aircraft, or the like. The vehicle 100 may further support one or more individual such as a driver, a passenger, or the like.

The ECU 102 may be coupled to each of the components of the vehicle 100 and may include one or more processors or controllers, which may be specifically designed for automotive systems. The functions of the ECU 102 may be implemented in a single ECU or in multiple ECUs. The ECU 102 may receive data from components of the vehicle 100, may make determinations based on the received data, and may control the operations of the components based on the determinations.

The vehicle 100 may be non-autonomous, fully autonomous, or semi-autonomous. In that regard, the ECU 102 may control various aspects of the vehicle 100 (such as steering, braking, accelerating, or the like) to maneuver the vehicle 100 from a starting location to a destination. In some embodiments, the vehicle 100 may be operated in an autonomous, semi-autonomous, or fully driver-operated state. In that regard, the vehicle 100 may be operated independently of driver control and, from time to time, without a person inside of the vehicle 100. The ECU 102 may facilitate such autonomous functionality.

The memory 104 may include any non-transitory memory and may store data usable by the ECU 102. For example, the memory 104 may store map data, may store instructions usable by the ECU 102 to drive autonomously, may store data usable by the ECU to diagnose faults within one or more component of the vehicle 100, or the like.

The power source 106 may include any one or more of an engine 114, a motor-generator 116, a battery 118, or a fuel cell circuit 120. The engine 114 may convert a fuel into mechanical power for propelling the vehicle 100. In that regard, the engine 114 may be a gasoline engine, a diesel engine, an ethanol engine, or the like.

The battery 118 may store electrical energy. In some embodiments, the battery 118 may include any one or more energy storage device including a battery, a flywheel, a super capacitor, a thermal storage device, or the like.

The fuel-cell circuit 120 may include a plurality of fuel cells that facilitate a chemical reaction to generate electrical energy. For example, the fuel cells may receive hydrogen and oxygen, facilitate a reaction between the hydrogen and the oxygen, and output electricity in response to the reaction. In that regard, the electrical energy generated by the fuel-cell circuit 120 may be stored in the battery 118 and/or used by the motor-generator 116 or other electrical components of the vehicle 100. In some embodiments, the vehicle 100 may include multiple fuel-cell circuits including the fuel-cell circuit 120.

The motor-generator 116 may convert the electrical energy stored in the battery 118 (or electrical energy received directly from the fuel-cell circuit 120) into mechanical power usable to propel the vehicle 100. The motor-generator 116 may further convert mechanical power received from the engine 114 or from wheels of the vehicle 100 into electricity, which may be stored in the battery 118 as energy and/or used by other components of the vehicle 100. In some embodiments, the motor-generator 116 may include a motor without a generator portion and, in some embodiments, a separate generator may be provided.

The location sensor 112 may include any sensor capable of detecting data corresponding to a current location of the vehicle 100. For example, the location sensor 112 may include one or more of a global positioning system (GPS) sensor 128, an inertial measurement unit (IMU) sensor 130, or the like. The GPS sensor 128 may detect data corresponding to a location of the vehicle. For example, the GPS sensor 128 may detect global positioning coordinates of the vehicle 100. The IMU sensor 130 may include one or more of an accelerometer, a gyroscope, or the like. The IMU sensor 130 may detect inertial measurement data corresponding to a position, a velocity, an orientation, an acceleration, or the like of the vehicle 100. The inertial measurement data may be used to identify a change in location of the vehicle 100, which the ECU 102 may track in order to determine a current location of the vehicle 100.

The image sensor 108 may be coupled to the main body and may detect image data corresponding to an environment of the vehicle 100. For example, the image sensor 108 may include a camera, a radar detector, a lidar detector, or any other image sensor capable of detecting light having any wavelength. The image sensor 108 may include one or multiple image sensors which may be oriented to detect image data in any direction relative to the vehicle 100. For example, the image sensor 108 may include four or more radar detectors to detect radar data on all four sides of the vehicle 100. The image sensor 108 may also or instead include a first camera to detect image data in a forward direction relative to the vehicle 100 and a second camera to detect image data in a rear direction relative to the vehicle 100.

The sensor 132 may include one or more of a sensor capable of detecting a status of a vehicle component, a sensor capable of detecting environmental conditions (including weather), a voltage sensor, a current sensor, a temperature sensor, a pressure sensor, a fuel gauge, an airflow sensor, an oxygen sensor, a sensor designed to detect a collision, or the like. In that regard, the sensor 132 may detect data that indicates an emergency condition (such as the vehicle 100 running out of fuel, running out of electricity, a collision involving the vehicle, incapacitation of a driver (e.g., based on an image of the driver), or the like). The ECU 102 may determine the emergency condition based on the sensor data.

The input device 138 may include any one or more input device such as a button, a keyboard, a mouse, a touchscreen, a microphone, or the like. The input device 138 may receive input from a user of the vehicle 100 such as a driver or a passenger.

The output device 140 may include any output device such as a speaker, a display, a touchscreen, or the like. The output device 140 may output data to a user of the vehicle such as a message received from a communication device (e.g., the primary network access device 110, the long-range radio transceiver 122, or the third network access device 124).

The primary network access device 110 may include a network access device capable of communicating via a wireless protocol. For example, the primary network access device 110 may communicate via Bluetooth, Wi-Fi, a cellular protocol, vehicle to vehicle (V2V) communications, Zigbee, or any other wireless protocol. The primary network access device 110 may be referred to as a data communication module (DCM) and may communicate with any device on the vehicle 100 and/or any remote device. For example, the primary network access device 110 may communicate with at least one of another vehicle 144 or a cellular tower 148. In some embodiments, the primary network access device 110 may be designed to communicate via a cellular or other long-range network.

The long-range radio transceiver 122 may transmit and/or receive data via radio waves and over one or more radio channel. For example, the long-range radio transceiver 122 may communicate via radio waves between 1 Megahertz (MHz) and 5 Gigahertz (GHz), between 1 MHz and 1 GHz, between 3 MHz and 100 MHz, between 3 MHz and 30 MHz, or the like. The long-range radio transceiver 122 may communicate with a radio tower 142, another vehicle 144, or the like. In some embodiments, the long-range radio transceiver may communicate with the vehicle 144 via the radio tower 142. In some embodiments, a message may be transmitted to the vehicle 144 via propagation over multiple radio towers, via one or multiple vehicle propagating the message, by a combination of radio towers and vehicles, or the like.

The third network access device 124 may communicate via a relatively short-range protocol such as Bluetooth or Wi-Fi. The third network access device 124 may communicate with a remote user device 146 (such as a mobile telephone, a laptop, a tablet, a desktop computer, a PDA, or the like), which may be associated with a user of the vehicle 100 and located in or near the vehicle 100. In that regard, the third network access device 124 may communicate with the cell tower 148 or the vehicle 144 via the remote user device (e.g., the third network access device 124 may transmit a message to the remote user device 146 which may then transmit the message to the cell tower 148 or the vehicle 144).

The ECU 102 may be designed to provide redundant control of the communication devices. For example, the ECU 102 may control the operation of the communication devices (the primary network access device 110, the long-range radio transceiver 122, and the third network access device 124) based on user input and environmental conditions. For example, if the ECU 102 determines that the primary network access device 110 is incapable of communications (e.g., if the vehicle 100 is out of range of cellular service) then the ECU 102 may control one or both of the long-range radio transceiver 122 or the third network access device 124 to transmit a message.

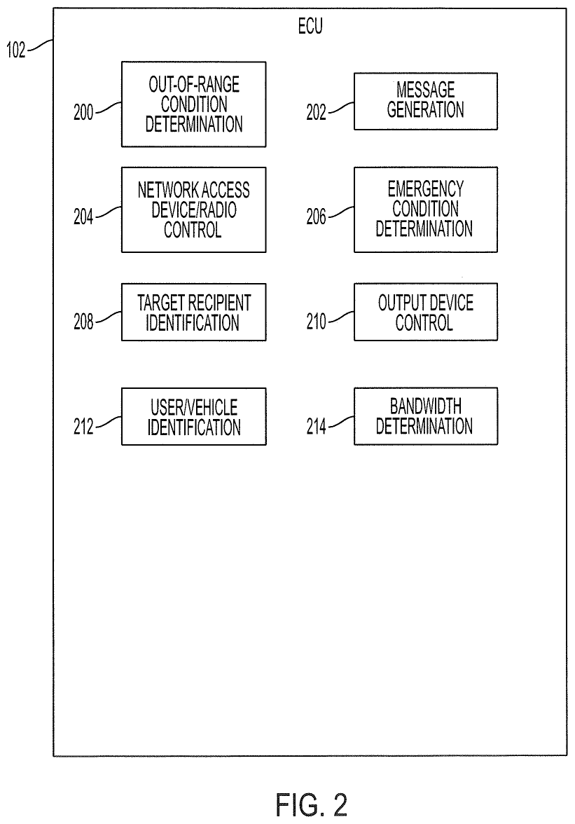

Referring now to FIG. 2, additional details of the ECU 102 are provided. The ECU 102 may be designed to perform various functions, some of which being shown in FIG. 2. The functions may be performed by software, hardware, firmware, or a combination thereof. The ECU 102 may perform an out of range condition determination function 200. Referring to FIGS. 1 and 2, the out of range condition determination function 200 may determine whether the primary network access device 110 is out of range of a network. For example, the out of range condition determination function 200 may determine that an out of range condition has occurred when the primary network access device 110 is incapable of communicating with a cellular network.

The ECU 102 may further perform a message generation function 202. The message generation function 202 may generate a message to be transmitted to a remote device (such as the radio tower 142, the vehicle 144, cell tower 148, the like) based on various inputs and based on which communication device the message is to be transferred by.

The ECU 102 may further perform a network access device/radio transceiver control function 204. The function 204 may be used to control the selected communication device to transmit a message generated in the message generation function 202, and may further be used to receive messages via one or more of the communication devices.

The ECU 102 may perform an emergency condition determination function 206. The function 206 may be used to identify or determine whether an emergency condition has occurred. For example, the emergency condition may include a collision with another vehicle or object (as detected by a contact sensor, deployment of airbags, or the like), incapacitation of a driver or passenger (as detected by a camera and the vehicle cabin), the vehicle running out of fuel or electrical energy, a fault within a vehicle component (e.g., if the engine fails to operate correctly), or the like.

The ECU 102 may further perform a target recipient identification function 208. The function 208 may determine a target recipient for a message to be transmitted by one of the communication devices. For example, target recipient may include an identifier of an individual, an identifier of a mobile device associated with an individual, an identifier of another vehicle, or the like. The function 208 may determine the target recipient based on user input, based on information stored in the memory 104 (e.g., the memory 104 may store data indicating that a message should be sent to a specific recipient in response to an emergency condition), or the like.

The ECU 102 may also perform an output device control function 210. The output device control function 210 may be used to control data output by the output device 140. For example, the ECU 102 may receive a message from another vehicle, may convert the message into information capable of being out by the output device 140, and may control the output device 140 to output the information.

The ECU 102 may further perform a user/vehicle identification function 212. The function 212 may be used to determine an identifier of a user of the vehicle 104 or an identifier of the vehicle 100. For example, the ECU 102 may determine an identifier of a user based on image data that includes the user, based on matching a key fob used to operate the vehicle to a specific user, or the like.

The ECU 102 may also perform a bandwidth determination function 214. The function 214 may be used to identify an available bandwidth on any of the communication devices. The function 214 may determine a bandwidth of the primary network access device 110, the long-range radio transceiver 122, or the third network access device 124. The bandwidth may be determined using any known technique such as calculating a difference between minimum amplitude or frequency on a radio channel, receiving a notification from the remote user device 146 regarding the available bandwidth available on the remote user device 146 (via the third network access device 124), or the like.

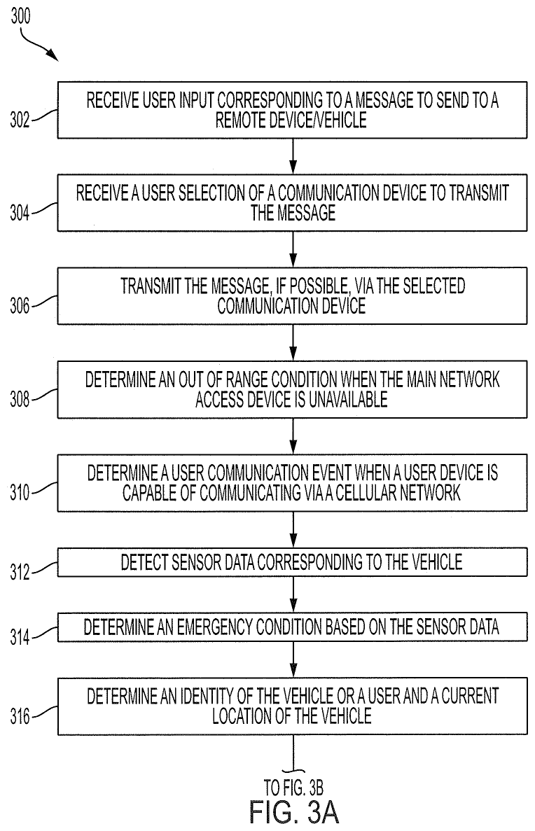

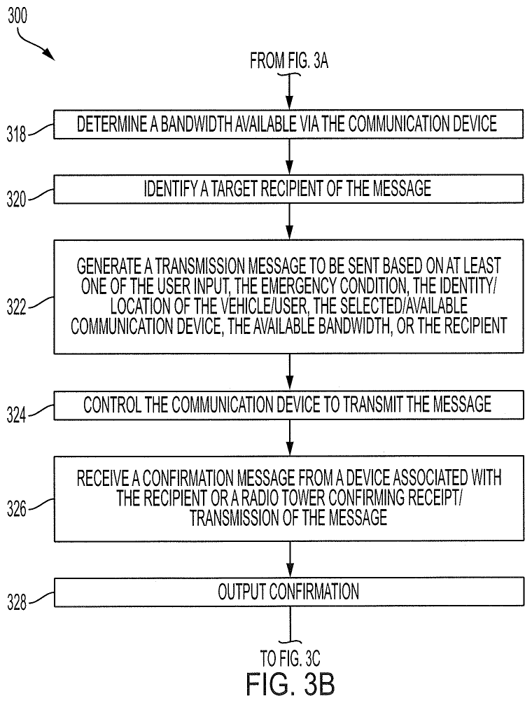

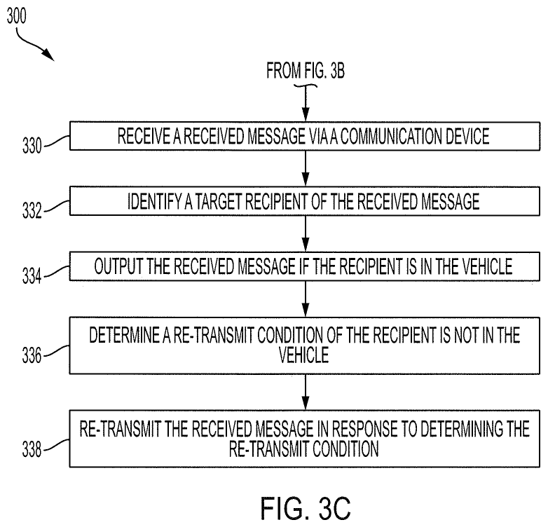

Referring now to FIGS. 3A, 3B, and 3C, a method 300 may be used by a vehicle or system similar to the vehicle 100 or the system 101 of FIG. 1 to provide redundant communications. The method 300 may include some or all of the blocks shown in FIGS. 3A, 3B, and 3C, and may likewise include additional blocks not shown in FIGS. 3A, 3B, and 3C.

In block 302, an input device of the vehicle may receive user input corresponding to a message to be transmitted to a remote device or a remote vehicle. For example, a user may provide input such as a current location of the vehicle, a personalized message (e.g., “let's meet at the lake trail”), or the like. The input may be received, for example, by the user typing a message, speaking a message, or the like.

In some embodiments and in block 304, the user may select a communication device for the message to be transmitted over. For example, the user may select a primary network access device (such as a device capable of communicating via a cellular network), a long-range radio transceiver, or a third network access device (e.g., a device capable of communicating with a local user device such as a cell phone via Bluetooth; the local user device may then communicate with a remote vehicle or a remote device). The user may make this selection via the input device such as pressing a button, selecting a location on a touchscreen, speaking a voice command, or the like.

In block 306, the ECU of the vehicle may control the selected communication device to transmit the message, if possible. In some embodiments, it may not be possible for the selected communication device to transmit the message. For example, if the main network access device is out of range of a cellular network then the primary network access device may be incapable of transmitting the message.

In block 308, the ECU may determine an out of range condition if the primary network access device is incapable of transmitting the message. The out of range condition may be determined in various manners. For example, the memory may store a map that indicates areas which are in range of the primary network access device and areas that are out of range of the primary network access device. Such locations may be referred to as a geo-fence. The ECU may compare the current location of the vehicle to the map to determine whether the primary network access device is in range or is out of range (e.g., to determine whether the current location is within or outside of the geo-fence and is thus covered or uncovered by the cellular network).

As another example, the primary network access device may transmit a message. In response to a lack of receiving a confirmation that the message has been received by a cell tower or a remote device, the ECU may determine that the primary network access device is out of range.

In block 310, the ECU may determine a user communication event in response to determining that a user device is capable of communicating via a cellular or other network. For example, the user device (e.g., a tablet, mobile phone, or the like) may determine whether it is connected to a cellular network and may transmit an indication of such connection to a third network access device (e.g., a vehicle communication device capable of communicating via a short-range wireless protocol, such as Bluetooth). In response to learning that the device is capable of communicating via a cellular or other network, the ECU may determine the user communication event. In that regard, the user communication event indicates that the user device is capable of transmitting and/or receiving messages over a relatively long-range protocol such as 3G, 4G, or the like.

In block 312, one or more sensor of the vehicle may detect sensor data corresponding to the vehicle or a component of the vehicle. For example, the sensor data may include or indicate that a collision has occurred, that the vehicle is low or out of fuel, that a battery of the vehicle is low or out of electrical power, that a user of the vehicle is injured or incapacitated, or the like.

In block 314, the ECU of the vehicle may analyze the sensor data and may determine an emergency condition based on the sensor data. For example, if the sensor data indicates that a collision has occurred then the ECU may determine an emergency condition corresponding to a collision of the vehicle. As another example, if the sensor data indicates that the vehicle is out of electrical power or fuel then the ECU may determine an emergency condition corresponding to a lack of power or fuel for the vehicle. As yet another example, if the sensor data indicates that a user of the vehicle is injured or incapacitated then the ECU may determine an emergency condition corresponding to the injury or the incapacitation.

In block 316, the ECU may determine an identity of the vehicle or a user of the vehicle, and may likewise determine a current location of the vehicle. The ECU may determine the current location of the vehicle based on the sensor data (e.g., a GPS sensor or an IMU sensor). The ECU may determine the identity of the vehicle in any of a variety of manners such as analyzing a memory which may store an identifier of the vehicle, determining a vehicle identification number (VIN) of the vehicle, or the like. The ECU may determine the identity of a user in any of a variety of manners such as analyzing a memory of which may store an identifier of the user, comparing a key fob to the memory to determine an identifier of the user associated with the key fob, comparing image data of the user to the memory to determine an identifier of the user, or the like.

In block 318, the ECU may determine an available bandwidth of one or more of the communication devices. The ECU may determine the available bandwidth in any of a variety of manners. For example, the ECU may determine the available bandwidth based on the protocol over which the specific communication device communicates (e.g., it may already be aware of the bandwidth of the long-range radio transceiver). As another example, the ECU may control one or more of the communication devices to transmit a query to a remote device, and the communication device may receive a response indicating the bandwidth. As yet another example, a local user device (such as a tablet or a mobile phone) may provide information to the communication device of the vehicle indicating the available bandwidth of the local user device.

In block 320, the ECU may identify a target recipient of the message. For example, a user may provide input in block 302 indicating a target recipient (such as a name of the recipient, an identifier of a device associated with the recipient, an identifier of a vehicle associated with the recipient, or the like). In some embodiments, the ECU may generate a message without receiving user input, such as in response to identifying an emergency condition. In such embodiments, the ECU may identify a target recipient to be an emergency service (such as a fire department, a police department, hospitals, or the like) and others within the proximity of the network access device by sending a message similar to a SOS message. In some embodiments, the memory of the vehicle may store one or more identifier corresponding to a device, vehicle, or user to be contacted in response to an emergency condition as an emergency contact, and the ECU may identify the target recipient based on the data stored in the memory.

In block 322, the ECU may generate a transmission message to be sent via one or more of the communication devices. The content of the transmission message may be based on at least one of the user input, the emergency condition, the identity and/or location of the vehicle or user, the selected and/or available communication device, the available bandwidth, or the identified recipient. For example, the user input may include content to be sent to a recipient. The user input may further include a selected communication device for transmitting the message. Based on this information, the ECU may control the selected communication device to transmit the content of the recipient. However, if the selected communication device is unavailable or out of range then the ECU may reformat the message to be sent via an alternative communication device (such as a long-range radio transceiver or a user device via a third network access device).

The ECU may reformat the message based on the available bandwidth of the alternative communication device. In some embodiments, the ECU may select the alternative communication device as the available device having the longest range, the greatest bandwidth, or the like. In some embodiments, the communication devices may be given a priority (e.g., the primary network access device may be priority one, the third network access device may be priority two, and the long-range radio transceiver may be priority three). In that regard, the ECU may go down the list of priorities until it finds a communication device that is capable of transmitting the message.

In some embodiments, the ECU may be required to reduce the content of the message based on the range of the alternative communication device or the bandwidth of the alternative communication device. In such embodiments, the ECU may remove information from the content that it deems relatively unimportant (such as special characters, words such as “the,” “a,” “an,” “and,” or the like). In some embodiments, the ECU may break the message up into multiple messages each capable of being sent via the alternative communication device. The ECU may further repackage the message into a protocol usable by the alternative communication device.

If an emergency condition has occurred, the ECU may create or generate a message that includes information such as a description of the emergency condition, a current location of the vehicle, an identifier of the vehicle or a user of the vehicle, or the like. For example, the ECU may generate a message such as “a blue Toyota Prius has been involved in a collision at GPS coordinates 123.32 by 321.12.” As another example, the ECU may generate a message such as “George in a silver Toyota Prius with a VIN number X123456789 has ran out of fuel on Highway 405 North between exit 32 and 33.”

A size of the message and the content of the message related to the emergency condition may be selected based on the available bandwidth or the range of the alternative communication device. In some embodiments, the message may further include instructions for recipients to retransmit the message if they are not the intended recipient. In that regard, the likelihood of the message reaching the intended recipient may be increased. For example, if the message is intended to be received by a police station, any other devices that receive the message may retransmit the message to increase the likelihood of the message reaching the police station.

In block 324, the ECU may control the selected communication device to transmit the message. If the communication device selected by the user is available then the ECU may control that communication device to transmit the message. However, in response to the selected communication device being incapable of transmitting the message, the ECU may select an alternative communication device having the greatest range or the greatest bandwidth to transmit the message. For example, if a user device in or near the vehicle is capable of communicating via a cellular network then the ECU may control a third network access device to transmit the message to the recipient via the user device. However, if the user device and the primary network access device are incapable of transmitting the message then the ECU may control a long-range radio transceiver to transmit the message.

In some embodiments, when the primary network access device is back in range, the ECU may control the primary network access device to transmit the message instead of, or in addition to, the second or third network access device.

In block 326, the communication device that transmitted the message may receive a confirmation message indicating that the transmitted message has been received. For example, the confirmation message may be received from a device or vehicle associated with the recipient. As another example, the confirmation message may be received from a radio tower, a non-related vehicle, or another intermediate device indicating that the message has been received and retransmitted towards the intended recipient. The ECU may receive the confirmation message from the communication device.

In block 328, the ECU may control an output device of the vehicle to output at least one of the confirmation message or information corresponding to the confirmation message. For example, if the transmitted message has been received and retransmitted by a vehicle or radio tower then the ECU may control the output device to output a notification of such retransmission.

In block 330, a communication device of the vehicle may receive a received message from a remote device or a remote vehicle. The received message may be received by any communication device of the vehicle such as the primary network access device, the long-range radio transceiver, the third network access device (e.g., via a user device), or the like.

In block 332, the ECU of the vehicle may analyze the received message and identify a target recipient based on the analysis. For example, the received message may include an identifier of the target recipient, and the ECU may determine the target recipient based on the identifier. The target recipient may include a user, a vehicle, a remote device associated with the user, or the like.

In block 334, the ECU may determine whether the target recipient includes the vehicle. For example, the ECU may compare the identifier of the target recipient to an identifier of users in the vehicle, to an identifier of user devices in the vehicle, to an identifier of the vehicle, or the like. If a match is found, then the ECU may control the output device to output the received message.

In block 336, the ECU may determine a retransmit condition if the target recipient is not located in the vehicle. In some embodiments, the ECU may only determine the retransmit condition if the received message includes an indicator to retransmit the message. In some embodiments, the ECU may always determine the retransmit condition if the target recipient is not located in the vehicle.

In block 338, the ECU may control the communication device to retransmit the received message in response to determining the retransmit condition.

Where used throughout the specification and the claims, “at least one of A or B” includes “A” only, “B” only, or “A and B.” Exemplary embodiments of the methods/systems have been disclosed in an illustrative style. Accordingly, the terminology employed throughout should be read in a non-limiting manner. Although minor modifications to the teachings herein will occur to those well versed in the art, it shall be understood that what is intended to be circumscribed within the scope of the patent warranted hereon are all such embodiments that reasonably fall within the scope of the advancement to the art hereby contributed, and that that scope shall not be restricted, except in light of the appended claims and their equivalents.

What is claimed is:

1. A system for redundant communications in a vehicle, the system comprising:
a primary network access device configured to transmit and receive first data using a first protocol;
a long-range radio transceiver configured to transmit and receive second data over at least one radio channel; and
an electronic control unit (ECU) coupled to the primary network access device and the long-range radio transceiver and configured to:
determine an out-of-range condition in response to the primary network access device being unable to at least one of transmit or receive the first data;
generate a transmission message to be sent via the long-range radio transceiver in response to determining the out-of-range condition; and
control the long-range radio transceiver to transmit the transmission message via the at least one radio channel in response to determining the out-of-range condition.

2. The system of claim 1, wherein the primary network access device is configured to communicate via a cellular network, and the ECU is further configured to determine the out-of-range condition in response to at least one of determining that the primary network access device is outside a range of the cellular network or in response to determining that a current location of the primary network access device is within or outside of a geo-fence corresponding to locations uncovered or covered by the cellular network.

3. The system of claim 1 further comprising a sensor configured to detect sensor data corresponding to the vehicle, wherein the ECU is further configured to:
determine an emergency condition based on the sensor data; and
generate the transmission message to include a message indicating the emergency condition.

4. The system of claim 3 wherein the emergency condition includes at least one of running out of fuel for powering the vehicle, running out of electrical energy for powering the vehicle, contact between the vehicle and an external object, or incapacitation of a driver of the vehicle.

5. The system of claim 1 further comprising an output device configured to output data, wherein the ECU is further configured to:
identify a target recipient of the second data;
include information corresponding to the target recipient in the transmission message;
receive a confirmation message from a device associated with the target recipient indicating that the transmission message was received by the device associated with the target recipient; and
control the output device to output data indicating that the confirmation message was received.

6. The system of claim 1 further comprising an output device configured to output data, wherein the ECU is further configured to:
receive a received message via the long-range radio transceiver; and
control the output device to output data corresponding to the received message.

7. The system of claim 6 wherein the ECU is further configured to:
identify a target recipient of the received message based on the received message;
determine a re-transmit condition in response to a failure to determine that the target recipient is in the vehicle; and
control the long-range radio transceiver to transmit the receive message in response to determining the re-transmit condition.

8. The system of claim 1 wherein the ECU is further configured to:
determine an identity of at least one of the vehicle or a user of the vehicle;
determine a current location of the vehicle; and
generate the transmission message to include the identity of the at least one of the vehicle or the user of the vehicle and to include the current location of the vehicle.

9. The system of claim 1 wherein the ECU is further configured to:
communicate with a receiver via the long-range radio transceiver;
determine a bandwidth of the at least one radio channel based on the communication with the receiver; and
generate the transmission message based on the bandwidth of the at least one radio channel such that at least a predetermined percentage of the bandwidth is utilized.

10. The system of claim 1 further comprising an input device configured to receive user input to be transmitted to a remote device, wherein the ECU is further configured to generate the transmission message based on the user input.

11. The system of claim 10 wherein the user input includes a selection of the primary network access device or the long-range radio transceiver, and the ECU is further configured to:
generate a main message to be transmitted via the primary network access device based on the user input, and control the primary network access device to transmit the main message in response to the selection including the primary network access device; and
generate the transmission message, and control the long-range radio transceiver to transmit the transmission message in response to the selection including the long-range radio transceiver.

12. The system of claim 1 further comprising a third network access device configured to communicate with a user device corresponding to a user of the vehicle, wherein the ECU is further configured to:
determine a user communication event in response to determining that the user device is capable of communicating via a cellular network;
generate a user message in response to determining the user communication event; and
control the third network access device to transmit the user message to the user device to be transmitted via the cellular network in response to determining the user communication event.

13. A system for redundant communications in a vehicle, the system comprising:
an output device configured to output data;
a primary network access device configured to transmit and receive first data using a first protocol;
a long-range radio transceiver configured to transmit and receive second data over at least one radio channel; and
an electronic control unit (ECU) coupled to the primary network access device and the long-range radio transceiver and configured to:
determine an out-of-range condition in response to the primary network access device being unable to at least one of transmit or receive the first data;
generate a transmission message to be sent via the long-range radio transceiver in response to determining the out-of-range condition;
control the long-range radio transceiver to transmit the transmission message via the at least one radio channel in response to determining the out-of-range condition; and
control the output device to output data indicating the out-of-range condition.

14. The system of claim 13 wherein the primary network access device is configured to communicate via a cellular network, and the ECU is further configured to determine the out-of-range condition in response to at least one of determining that the primary network access device is outside a range of the cellular network or in response to determining that a current location of the primary network access device is within or outside of a geo-fence corresponding to locations uncovered or covered by the cellular network.

15. The system of claim 13 further comprising an output device configured to output data, wherein the ECU is further configured to:
receive a received message via the long-range radio transceiver;
control the output device to output data corresponding to the received message;
identify a target recipient of the received message based on the received message;
determine a re-transmit condition in response to a failure to determine that the target recipient is in the vehicle; and
control the long-range radio transceiver to transmit the receive message in response to determining the re-transmit condition.

16. The system of claim 13 further comprising an output device configured to output data, wherein the ECU is further configured to:
identify a target recipient of the second data;
include information corresponding to the target recipient in the transmission message;
receive a confirmation message from a device associated with the target recipient indicating that the transmission message was received by the device associated with the target recipient; and
control the output device to output data indicating that the confirmation message was received.

17. The system of claim 13 further comprising an input device configured to receive user input to be transmitted to a remote device, the user input including a selection of the primary network access device or the long-range radio transceiver, wherein the ECU is further configured to:
generate a main message to be transmitted via the primary network access device based on the user input, and control the primary network access device to transmit the main message in response to the selection including the primary network access device; and
generate the transmission message, and control the long-range radio transceiver to transmit the transmission message in response to the selection including the long-range radio transceiver.

18. A method for redundant communications in a vehicle, the method comprising:
transmitting and receiving first data via a primary network access device using a first protocol;
determining, by an electronic control unit (ECU), an out-of-range condition in response to the primary network access device being unable to at least one of transmit or receive the first data;
generating, by the ECU, a transmission message to be sent via a long-range radio transceiver over at least one radio channel in response to determining the out-of-range condition; and
controlling, by the ECU, the long-range radio transceiver to transmit the transmission message via the at least one radio channel in response to determining the out-of-range condition.

19. The method of claim 18, further comprising:
detecting, by a sensor, sensor data corresponding to the vehicle;
determining, by the ECU, an emergency condition based on the sensor data; and
generating, by the ECU, the transmission message to include a message indicating the emergency condition.

20. The method of claim 18 further comprising:
determining, by the ECU, an identity of at least one of the vehicle or a user of the vehicle;
determining, by the ECU, a current location of the vehicle; and
generating, by the ECU, the transmission message to include the identity of the at least one of the vehicle or the user of the vehicle and to include the current location of the vehicle.
